(19) United States
(12) Patent Application Publication
(10) Pub. No.: US 2014/0276279 A1
(43) Pub. Date: Sep. 18, 2014

(54) MASSAGE EARPHONE

(71) Applicants: FIH (Hong Kong) Limited, Kowloon (HK); SHENZHEN FUTAIHONG PRECISION INDUSTRY CO., LTD., Shenzhen (CN)

(72) Inventor: JIAN-HUI LI, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/955,256

(22) Filed: Jul. 31, 2013

(30) Foreign Application Priority Data
Mar. 18, 2013 (CN) 2013100855109

(51) Int. Cl. A61H 1/00

(52) U.S. Cl. CPC A61H 1/008
USPC 601/136

(57) ABSTRACT

A massage earphone includes a main body, a clamp assembly and a connecting element connecting the main body to the clamp assembly. The clamp assembly includes a first clamping plate, a second clamping plate and a shaft connecting the first clamping plate to the second clamping plate. The first clamping plate includes a first massage portion, and the second clamping plate includes a second massage portion. The first clamping plate and the second clamping plate pivot around the shaft to clamp an auricle of a user's ear between the first massage portion and the second massage portion.

### BACKGROUND

1. Technical Field

The disclosure generally relates to earphones and more particularly to a massage earphone for massaging ears.

2. Description of the Related Art

Human ear includes an auricle with a plurality of pressure points. The plurality of pressure points corresponds to various organs of human body reflex zones. Pressure points massage can promote blood circulation and improve health. Generally, people uses earphone to listen to music or make calls, and it would be beneficial if the earphone can massage the ears.

Therefore, there is room for improvement within the art.

### BRIEF DESCRIPTION OF THE DRAWINGS

Many aspects of an exemplary massage earphone can be better understood with reference to the following drawings. The components in the drawings are not necessarily drawn to scale, the emphasis instead being placed upon clearly illustrating the principles of the exemplary massage earphone. Moreover, in the drawings, like reference numerals designate corresponding parts throughout the several views. Wherever possible, the same reference numbers are used throughout the drawings to refer to the same or like elements of an embodiment.

FIG. 1 is an exploded view of a massage earphone, according to an exemplary embodiment.

FIG. 2 is similar to FIG. 1, but shown from another angle.

FIG. 3 is an assembled view of the massage earphone shown in FIG. 1.

FIG. 4 is similar to FIG. 3, but shown from another angle.

### DETAILED DESCRIPTION

FIG. 1 and FIG. 2 show exploded views of a massage earphone 100 for massaging ears, according to an exemplary embodiment. The massage earphone 100 can be used in a wireless mode or a wired mode. The massage earphone 100 includes a main body 10, a clamp assembly 20, and a connecting element 30. The main body 10 is connected to the clamp assembly 20 by the connecting element 30. The connecting element 30 is made of resilient material, such as rubber or plastic.

In the embodiment, the main body 10 is substantially cubic, and includes a first surface 101 and a second surface 103 opposite to the first surface 101. An earplug 11 is located on the first surface 101, and a fixing element 13 is located on the second surface 103. In the embodiment, the fixing element 13 is substantially a cylinder, and defines a through hole 131 along a diametrical direction of the fixing element 13.

The clamp assembly 20 includes a first clamping plate 21, a second clamping plate 23, and a shaft 25. The first clamping plate 21 has a similar structure with the second clamping plate 23, and the first clamping plate 21 is connected to the second clamping plate 23 by the shaft 25.

The first clamping plate 21 includes a first positioning portion 211 and a first massage portion 213. The first massage portion 213 is a round shaped plate, and is formed at one end of the first clamping plate 21. A plurality of protrusions 2131 are located on a surface of the first massage portion 213. The plurality of protrusions 2131 can be made of rubber, plastic or magnetic materials. The first positioning portion 211 protrudes from one surface of the first clamping plate 21 and defines a first shaft hole 2111.

The second clamping plate 23 includes a second positioning portion 231 protruding from one surface of the second clamping plate 23 and a fastening element 235 formed on an opposite surface of the second clamping plate 23. The second positioning portion 231 defines a second shaft hole 2311 corresponding to the first shaft hole 2111. The shaft 25 is rotatably received in the first shaft hole 2111 and the second shaft hole 2311. The fastening element 235 is similar to the fixing element 13 and is substantially a cylinder. The fastening element 235 defines a central hole 2351 corresponding to the through hole 131. A second massage portion 233 is a round shaped plate, and is formed at one end of the second clamping plate 23. A plurality of protrusions 2331 are located on a surface of the second massage portion 233. The plurality of protrusions 2331 can be made of rubber, plastic or magnetic materials.

Opposite ends of the shaft 25 respectively have a flange 251 for preventing the shaft 25 from separating from the first clamping plate 21 and the second clamping plate 23. In this embodiment, the flange 251 is formed on the opposite ends of the shaft 25 by rivet joint. A torsion spring 253 is coiled around the shaft 25 and is resisted between the first clamping plate 21 and the second clamping plate 23.

The assembly process of the massage earphone 100 is as follows:

The first clamping plate 21 and the second clamping plate 23 are close fitting, and the shaft 25 passes through the first shaft hole 2111, the torsion spring 253 and the second shaft hole 2311 successively. After the shaft 25 is assembled to the first shaft hole 2111 and the second shaft hole 2311, the flange 251 is formed on the opposite ends of the shaft 25 by rivet joint for preventing the shaft 25 from separating from the first clamping plate 21 and the second clamping plate 23. The torsion spring 253 is positioned between the first clamping plate 21 and the second clamping plate 23. The plurality of protrusions 2131 of the first clamping plate 21 and the plurality of protrusions 2331 of the second clamping plate 23 are close fitting. The first clamping plate 21 and the second clamping plate 23 can pivot around the shaft 25 to separate the first massage portion 213 and the second massage portion 233, and a space is defined between the first massage portion 213 and the second massage portion 233. The connecting element 30 passes through the through hole 131 and the central hole 2351 (interference fit) to connect the main body 10 to the clamp assembly 20.

When the massage 100 is used, the earplug 11 is inserted into an ear canal of the user. The first clamping plate 21 and the second clamping plate 23 are pressed to separate the first massage portion 213 and the second massage portion 233, and allows the auricle of the user's ear to be clamped between the first massage portion 213 and the second massage portion 233. The plurality of protrusions 2131, 2331 resist against the auricle and massage pressure points on the auricle. The connecting element 30 is bent to adjust the location of the clamp assembly 20 clamped on the auricle.

User can massage the ears while listening to music or making calls by the massage earphone 100.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A massage earphone comprising:
a main body;
a clamp assembly comprising a first clamping plate, a second clamping plate, and a shaft pivotably connecting the first clamping plate to the second clamping plate, the first clamping plate comprising a first massage portion, and the second clamping plate comprising a second massage portion; and
a connecting element connecting the main body to the clamp assembly;
wherein the first clamping plate and the second clamping plate pivot around the shaft to clamp an auricle of a user's ear between the first massage portion and the second massage portion.

2. The massage earphone as claimed in claim 1, wherein a plurality of protrusion are located on a surface of the first massage portion, and a plurality of protrusions are located on a surface of the second massage portion.

3. The massage earphone as claimed in claim 2, wherein a first positioning portion protrudes from a sidewall of the first clamping plate and defines a first shaft hole; a second positioning portion protrudes from a sidewall of the second clamping plate and defines a second shaft hole corresponding to the first shaft hole; the shaft is rotatably received in the first shaft hole and the second shaft hole.

4. The massage earphone as claimed in claim 3, further comprises a torsion spring, wherein the torsion spring is coiled around the shaft and is resisted between the first clamping plate and the second clamping plate.

5. The massage earphone as claimed in claim 4, wherein opposite ends of the shaft respectively have a flange, after the shaft is assembled to the first shaft hole and the second shaft hole, the flange is formed on the opposite ends of the shaft by rivet joint for preventing the shaft from separating from the first clamping plate and the second clamping plate.

6. The massage earphone as claimed in claim 4, wherein the main body comprises a fixing element defining a through hole; a fastening element opposite to the second positioning portion is formed on an opposite sidewall of the second clamping plate, the fastening element defines a central hole corresponding to the through hole; the connecting element passes through the through hole and the central hole to connect the main body to the clamp assembly.

7. The massage earphone as claimed in claim 6, wherein the main body further comprises a first surface and a second surface opposite to the first surface; an earplug is located on the first surface, and the fixing element is located on the second surface.

8. The massage earphone as claimed in claim 2, wherein the plurality of protrusions are made of rubber, plastic or magnetic materials.

9. The massage earphone as claimed in claim 1, wherein the connecting element is made of resilient materials and is bended to adjust the location of the clamp assembly clamped on the auricle.

10. A massage earphone comprising:
a main body;
a clamp assembly comprising a first clamping plate, a second clamping plate, and a shaft pivotably connecting the first clamping plate to the second clamping plate; and
a connecting element connecting the main body to the clamp assembly;
wherein an end of the first clamping plate and an end of the second clamping plate are close fitting, the first clamping plate and the second clamping plate pivot around the shaft to clamp an auricle of a user's ear between the first clamping plate and the second clamping plate.

11. The massage earphone as claimed in claim 10, wherein the end of the first clamping plate forms a first massage portion with a plurality of protrusions, and the end of the second clamping plate forms a second massage portion with a plurality of protrusions.

12. The massage earphone as claimed in claim 11, wherein a first positioning portion protrudes from a sidewall of the first clamping plate and defines a first shaft hole; a second positioning portion protrudes from a sidewall of the second clamping plate and defines a second shaft hole corresponding to the first shaft hole; the shaft is rotatably received in the first shaft hole and the second shaft hole.

13. The massage earphone as claimed in claim 12, further comprises a torsion spring, wherein the torsion spring is coiled around the shaft and is resisted between the first clamping plate and the second clamping plate.

14. The massage earphone as claimed in claim 13, wherein opposite ends of the shaft respectively have a flange, after the shaft is assembled to the first shaft hole and the second shaft hole, the flange is formed on the opposite ends of the shaft by rivet joint for preventing the shaft from separating from the first clamping plate and the second clamping plate.

15. The massage earphone as claimed in claim 14, wherein the main body comprises a fixing element defining a through hole; a fastening element opposite to the second positioning portion is formed on an opposite sidewall of the second clamping plate, the fastening element defines a central hole corresponding to the through hole; the connecting element passes through the through hole and the central hole to connect the main body to the clamp assembly.

16. The massage earphone as claimed in claim 15, wherein the main body further comprises a first surface and a second surface opposite to the first surface; an earplug is located on the first surface, and the fixing element is located on the second surface.

17. The massage earphone as claimed in claim 11, wherein the plurality of protrusions are made of rubber, plastic or magnetic materials.

18. The massage earphone as claimed in claim 10, wherein the connecting element is made of resilient materials and is bended to adjust the location of the clamp assembly clamped on the auricle.
